(19) United States
(12) Patent Application Publication
(10) Pub. No.: US 2021/0224800 A1
(43) Pub. Date: Jul. 22, 2021

(54) Transaction-Based Rewards Points Notification

(71) Applicant: The Toronto-Dominion Bank, Toronto (CA)

(72) Inventors: Adrian Bloy, Ottawa (CA); Kayla Ann Duncan, Toronto (CA); Anchal Gawri, Toronto (CA); Rafi Jason Kandaharian, Toronto (CA); Michael James Taggart, Ottawa (CA); Samara Jean Seg Ayoub, Toronto (CA); Romy Moghaizel, Toronto (CA)

(73) Assignee: The Toronto-Dominion Bank, Toronto (CA)

(21) Appl. No.: 16/744,989

(22) Filed: Jan. 16, 2020

(51) Int. Cl. G06Q 20/40; G06Q 20/20; G06Q 30/02

(52) U.S. Cl. CPC G06Q 20/401; G06Q 30/02; G06Q 20/20; G06Q 20/405

(57) ABSTRACT

The present disclosure involves, systems, software, and computer-implemented methods for providing, at the time of a transaction, an estimate of a reward earned by a customer for the particular transaction. One example method comprises receiving information associated with a data exchange between at least a computing device of a user and a computing device of an entity, the information comprising information indicative of a card type used in the data exchange, a transaction amount, and a category code associated with the entity; identifying one or more accelerators; selecting, based on at least one of the information associated with the data exchange, a particular accelerator applicable to the data exchange; determining, at a time concurrent with the data exchange, a points estimate for the data exchange based on the transaction amount and the particular accelerator; and transmitting a notification comprising the transaction amount and the points estimate for the data exchange.

### BACKGROUND

Credit cards are used by customers to complete financial transactions, both in person and online. Some credit card companies offer rewards to their customers to incentivize the customers to use a particular company's credit card rather than another form of payment, such as cash, check, or other credit card. The rewards may be in the form of points or cash paid back to the customer.

### SUMMARY

The present disclosure involves systems, software, and computer-implemented methods for providing, at the time of a transaction, an estimate of a reward earned by a customer for the particular transaction. An example computer-implemented method comprises: receiving, at a central server, information associated with a first data exchange between at least a computing device associated with a user and a computing device associated with an entity, the information comprising information indicative of a card type used in the first data exchange, a transaction amount, and a category code associated with the entity; identifying, by the central server and based on at least one of the information associated with the first data exchange, one or more accelerators; selecting, by the central server and among the one or more accelerators and based on at least one of the information associated with the first data exchange, a particular accelerator applicable to the first data exchange; determining, by the central server and at a time concurrent with the first data exchange, a points estimate for the first data exchange based on the transaction amount and the selected particular accelerator; and transmitting, by the central server to a computing device associated with the user, a notification comprising the transaction amount and the points estimate for the first data exchange.

In some implementations, the entity comprises a merchant. In some implementations, the first data exchange comprises a transaction.

In some implementations, the notification is provided concurrent (e.g., in real-time), as close to concurrent, with the first data exchange. In some implementations, the notification further includes a breakdown of the points estimate based on the first data exchange.

In some implementations, the one or more accelerators are each associated with a respective rate or multiplier. In some implementations, the one or more accelerators are identified based on the card type. In some implementations, the particular accelerator among the one or more accelerators is selected based on the category code.

In some implementations, the method further includes identifying a second data exchange related to the first data exchange; and revising the points estimate for the first data exchange based on information associated with the second data exchange. In some implementations, the first data exchange is associated with a first time and the second data exchange is associated with a second, different time. In some implementations, the second time occurs after the first time.

In some implementations, the method further includes identifying a data exchange type of the first data exchange; and based on the data exchange type, determining whether to provide the points estimate of the first data exchange to the computing device associated with the user.

In some implementations, the method further includes identifying a data exchange type of the first data exchange; and determining, based on the transaction type, whether to provide the points estimate for the transaction, wherein the points estimate for the first data exchange is not provided to the user if the data exchange type is associated with at least one of (i) frequent holds or (ii) frequent occurrences of actual transaction amounts differing from actual billed amounts.

In some implementations, a memory may be used to store a repository of multiplier-based calculations, data associated with the plurality of card types, and data associated with a plurality of customers.

In some implementations, the method further includes identifying one or more additional accelerators associated with previously-selected categories, wherein determining the points estimate for the first data exchange is further based on the identified one or more additional accelerators.

The technical solutions described herein provide a number of benefits to financial institutions and their customers. Implementing the technical solutions described herein, financial institutions can proactively (e.g., in real-time) communicate with their customers via notifications and alerts to provide information to those customers that the customers previously either could not access on their own or that were otherwise cumbersome to obtain. Moreover, by proactively providing customers with information pertaining to rewards points earned for each transaction at the time of the transaction, engagement in rewards programs may be increased, thereby increasing the number of customers of those financial institutions and also decrease attrition. By providing information regarding the value of reward points and rewards program, customers and potential customers may find those rewards programs to be more appealing.

Previously, customers wishing to learn their rewards points account balance would be required to directly contact their financial institutions to obtain this information. Consequently, financial institutions were inundated with a large volume of customers inquiring as to the number of points earned in a recent transaction or to request information about rewards points missing from their accounts. Implementations described herein would reduce the volume of communication from customers requesting such information because customers would be provided with reward points estimates concurrent with their transactions and also be able to access information about reward points associated with particular transactions.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a conceptual diagram of a system for sharing content and collectively providing shared content.

FIG. 2 is a sequence diagram depicting an example of steps taken by a customer of a financial institution.

FIG. 3 is a schematic diagram depicting the inputs and outputs used by the system and methods described herein.

FIG. 4 is an example real-time notification displayed on a user's computing device.

FIG. 5 is a flow chart of a method for determining rewards points estimate for a transaction according to a first embodiment.

FIGS. 6A and 6B are example displays on a user's computing device including a notification and a breakdown of rewards points earned.

FIG. 7 shows an example of a computer device and a mobile computer device that can be used to implement the techniques described here.

### DETAILED DESCRIPTION

In general, this document describes mechanisms for providing, at the time of, or immediately after completion of, a transaction, an estimate of a reward earned by a customer for the particular transaction. Currently, customers of financial institutions, such as credit card companies, do not have access to transaction-level reward points at the time of authorization for a particular transaction, as points and loyalty rewards may be managed by a third-party, or may otherwise be handled separately from individual transactions. For example, these customers are not provided with a breakdown of reward points that were earned for a particular purchase at the time of that purchase. Instead, customers can only access monthly or yearly point totals, which are provided in monthly or yearly statements and the end of billing cycles. In some instances, customers can request access to transaction-level point information if their financial institutions allow for it, but such access is limited to transactions that have already been posted, rather than at the time of the transaction. Moreover, in these instances, a customer is generally required to request such access through means outside of the financial institution itself (e.g., a website that is not integrated in the financial institution's own website). Additionally, while customers can generally receive notifications about a particular transaction in real-time or close to real-time (e.g., through a mobile application provided by the financial institution), such notifications do not provide real-time information regarding earned or estimated earned points related to a particular transaction. As such, customers are not aware at a time of a transaction as to the number of points earned for a particular transaction, particularly where reward accelerators and other variances on reward earning may differ based on a particular transaction or transaction type.

Presented herein are tools and methods for providing, at the time of a transaction, an estimate of a reward earned by a customer for the particular transaction. In particular, a tool is provided that calculates, at a time of a transaction, an estimate of the reward points earned for that transaction. After the estimate is calculated, the tool can provide the customer with a notification of the points estimate concurrent with the transaction. For example, the tool can notify the customer via a push notification on the customer's mobile computing device (e.g., smart phone) using an application running on the device. The tool can also provide the customer with transaction-level accelerator points for all of the customer's transactions. In particular, the tool can provide a listing of the customer's transaction, including a breakdown of rewards points estimates for each of those transactions. In some cases, an accelerator used for each transaction is also listed. This breakdown can be provided to the customer when the customer views his or her account via the financial institution's website or application interface. The breakdown can also be provided to the customer, for example, in monthly statements provided to the customer.

For example, a customer of a financial institution may be enrolled in real-time notifications via a mobile application provided by the financial institution. When the customer makes a purchase at a merchant (e.g., an online merchant or via an in-person transaction), an estimate of rewards points is calculated for the purchase. The customer then receives a notification of the purchase amount and the points estimate for the purchase.

The implementations described herein provide a number of benefits. For example, financial institutions can proactively communicate with customers via notifications and alerts. Additionally, engagement in rewards programs can be increased by providing knowledge of the value of reward points and rewards program, thereby also decreasing attrition. In the past, customers frequently contacted financial institutions to inquire as to the number of points earned in a recent transaction or to request information about rewards points missing from their accounts. Implementations described herein would reduce the volume of communication from customers requesting such information because customers would be provided with reward points estimates concurrent with their transactions and also be able to access information about reward points associated with particular transactions.

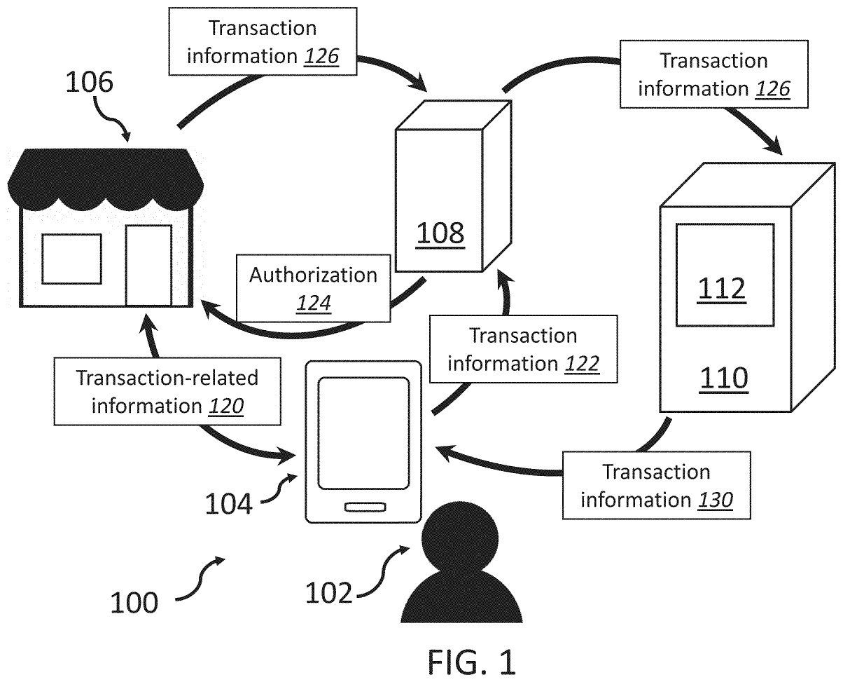

Turning to the illustrated example implementation, FIG. 1 shows a conceptual diagram of a system 100 for providing, at the time of a transaction, an estimate of a reward earned by a customer for the particular transaction. A user 102 interacts with a computing device 104. The computing device 104 may be mobile computing device (e.g., smart phone, laptop) located either at or remote from a merchant 106 or a payment terminal of the merchant 106. Using the computing device 104, the user makes a purchase from a merchant 106. The computing device 104 may be located at a physical location associated with the merchant 106 or remote from the merchant 106. During this transaction, if the computing device 104 is a not a device belonging to or associated with the merchant 106, the computing device 104 may send to and receive data from a computing device associated with the merchant 106, including transaction-related information 120. While only one computing device 104 is shown in FIG. 1, any number of computing devices may be used. To complete the purchase, the computing device 104 collects transaction information from the user, including, for example, a type of credit card or debit card used in the transaction and a number associated with the card. In some instances, if the computing device 104 is not associated with the merchant 106, the computing device 104 transmits the collected transaction-related information 120 to a computing device at the merchant 106. Then, either the computing device 104 (if not directly associated with the merchant) or a computing device at the merchant further determines the transaction amount and one or more merchant category codes (MCC) associated with the merchant 106.

After collecting the transaction information, either the computing device 104 provides transaction information 122 to an authorization service 108, or a computing device at the merchant 106 transmits the transaction information 126 to the authorization service 108 and provides authorization 124 for the transaction. The authorization service 108 may be an entity that provides payment processing services, merchant services, and related payment services. The authorization service 108 receives the transaction information 126 from the merchant 106 and, if appropriate, authorizes 124 the transaction. A set of suitable authorization rules can be applied by the authorization service 108 to ensure only allowed transactions are performed. The authorization service 108 then provides the transaction information 128 to a central server 110. In some instances, the central server 110 is operated by a financial institution associated with the type of payment used by the user 102 (e.g., the issuer of a credit card).

The central server 110 stores information in a database 112 that can be used to determine if any accelerator or points multipliers apply to the particular transaction. In particular, the database 112 stores information relating to card types, accelerators (e.g., earn rates, multipliers) associated with each card type, customer information, and MCC codes. The customer information may include, for example, whether a customer is enrolled in real-time notifications of transaction information and accelerators that are specific to a customer. Regarding the latter, in some instances, a customer may have a promotional rate that provides a particular accelerator. In some instances, the selection of one or more accelerators may be based on the card type, a customer's personal selection (e.g., select two categories of merchants for which the same or different accelerators may be applied), type of category of merchant, type of category of transaction, one or more promotions, or the like. This information, and one or more accelerators associated with card type, personal selection, category type, transaction type, or promotions, may further be stored in the database 112.

The database 112 is stored in a memory in the central server 110. In some instances, the memory stores one or more of a repository of multiplier-based calculations, data associated with a plurality of card types, and data associated with a plurality of customers. The multiplier-based calculations may comprise algorithms and equations used to calculate rewards points estimates. The data associated with the plurality of card types may include information identifying the card types (e.g., a name or special identifier for the card) and a plurality of accelerators associated with the respective card types. For instance, for a specific card type, there may be multiple potential accelerators used to determine a rewards points estimate. The selection of the particular accelerator(s) to be used may be dependent, for example, the type of transaction or on one or more MCC codes associated with the transaction.

The central server 110 receives transaction information 128 from the authorization service 108 and proactively calculates points estimates for transactions upon receipt of the transaction information. The calculation may be limited to transactions associated with customers who have opted to receive real-time notifications of transaction information.

In order to perform the calculation, the central server 110 determines one or more accelerators associated with the card type and/or account, selects at least one accelerator that is applicable to the transaction (e.g., multiple accelerators may be associated with a transaction), and calculates a points estimate for the transaction based on the transaction amount and the selected accelerator. If multiple accelerators are associated with a transaction and/or card type, a relatively higher-earning accelerator may be selected in some instances. In others, the accelerators may be combined or may affect each other, such that the combination, product, or additive of the accelerators can be applied. Other such interactions may also be possible. The central server 110 then provides the points estimate 130, or other rewards information related to the transaction, to a computing device associated with the user 102 in real time.

In some instances, the central server 110 determines the one or more accelerators based on a customer's personal selection (e.g., select two categories of merchants), type of category of merchant, type of category of transaction, one or more promotions, or the like. In these instances, the central server 110 retrieves information relating to these factors from the database 112 and selects at least one accelerator that is applicable to the transaction.

In some instances, the user may receive the points estimate on the same device 104 he or she used to make the purchase. For example, if a user 102 is making an online purchase on her smart phone, the central server 110 transmits the notification of points estimate to the user's smart phone. In other instances, a user 102 may make a purchase at a merchant's payment terminal and receive the notification from the central server 110 at the user's own computing device. The same or different communications channels may be used to perform the transaction (e.g., online merchant via a laptop computer) and receive the notification (e.g., via a web notification presented in a browser of the laptop computer or via a push notification transmitted separately to a mobile device different than the laptop computer).

In some instances, the central server 110 may receive additional information from the authorization service 108. For example, if the user 102 returns a purchased item, the merchant 106 may send updated transaction information to the authorization service 108, which in turn sends the transaction information to the central server 110. The central server 110 then revises the previous points estimate based on the additional information. In some instances, the central server 110 may have previously received a hold or authorized amount for the transaction. If the revised amount is different than the hold or authorized amount (e.g., less than or greater than), then a revised calculation based on the updated transaction amount is performed to provide an updated rewards points estimate.

The central server 110 includes logic specific to certain transactions. For transactions that frequently involve holds or authorization amounts that are different from the actual billed amounts (e.g., gas stations), the central server 110 may not provide an estimate. Alternatively, in these instances, the central server 110 provides an estimate with a disclaimer that the actual credited points may be different.

The user's computing device (e.g., 104) has installed on it a mobile application provided by a financial institution that issued the form of payment used by the user 102. For example, the computing device has a mobile application of a credit card issuer. The user's computing device receives, from the central server 110, information indicative of the points estimate. For example, the central server 110 notifies the user 102 of the points estimate via a push notification on the user's device. In some instances, the central server 110 further provides a breakdown of points for the user that show the number of rewards points earned for each transaction that the user has made.

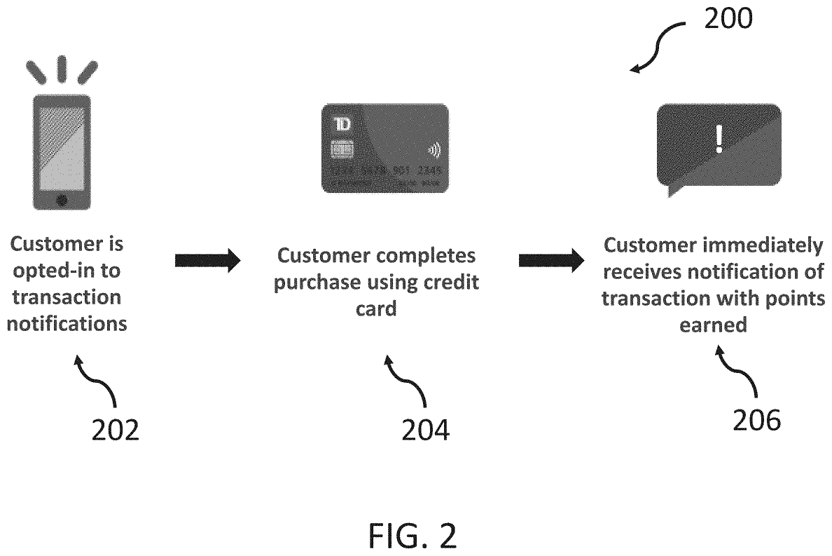

FIG. 2 is a sequence diagram depicting an example of steps 200 taken by a customer of a financial institution. At step 202, a customer of a financial institution opts in to receive notifications regarding transactions. The customer may, for example, use a computing device (e.g., a smart phone or tablet) and download an application provided by the financial institution to access his or her account. In the account settings, the customer can elect to opt in to receive notifications (e.g., push notifications or alerts) from the financial institution application regarding transactions that the customer makes using an account that the customer holds with the financial institution.

At step 204, the customer completes a transaction (e.g., a purchase) using payment associated with the financial institution. For example, the customer may have a credit card with the financial institution and may make a purchase using that credit card.

At step 206, the customer immediately (e.g., at the time of the purchase) receives a notification of the transaction (e.g., purchase). The notification may be provided as a push notification or alert from the application. The notification includes the amount of the transaction and an estimate of the rewards points earned with the transaction. In some instances, additional information may be provided in the notification, such as an identifier of a merchant associated with the transaction, the goods or services purchased in the transaction, a date and time associated with the transaction, and information used to calculate the estimate of the rewards points (e.g., accelerator).

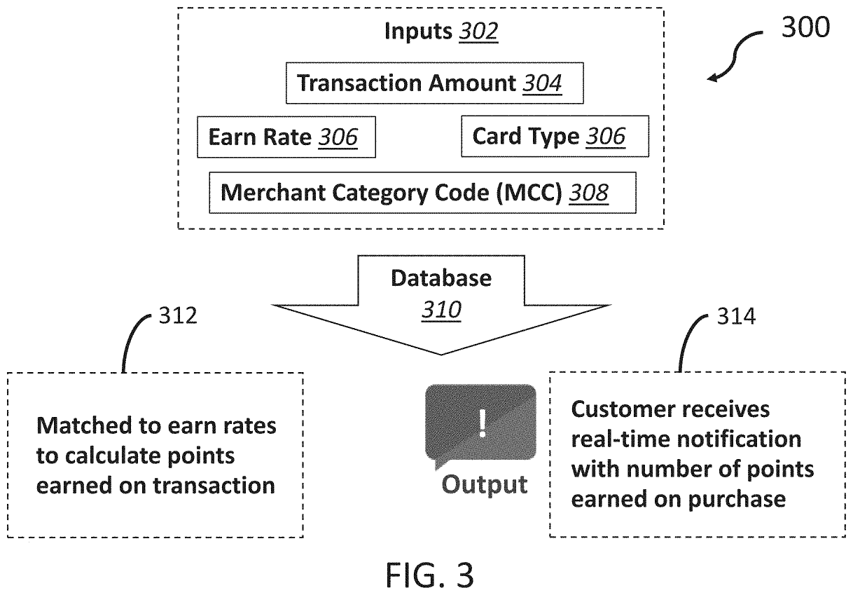

FIG. 3 is a schematic diagram depicting the inputs and outputs used by the system and methods described herein. In particular, a number of inputs 302 are used to determine a rewards point estimate. For example, one or more of a transaction amount 304, an earn rate 306, a card type 308, and a merchant category code (MCC) may be used as inputs to calculate the estimate. The transaction amount 304 is the amount of money that a customer authorized for payment for goods or services in a particular transaction. The earn rate 306 is a rate at which a customer earns rewards points. The earn rate 306 may be different for different customers of the same form of payment or may vary if certain customers are given a special earn rate (e.g., a promotional earn rate). Earn rates 306 may also vary depending on the type or form of payment used. The card type 308 denotes the type of payment that a customer uses for a transaction. This may identify, for example, whether the card is a credit card or a debit card, the type of account associated with the payment, and/or the particular financial institution associated with the payment used. The merchant category code 310 is an alphanumeric code that references a particular category of merchant. In some instances the merchant category code 310 is a four-digit number listed in ISO 18425 for retail financial services that classifies a business by the types of goods or services it provides.

Using a database 312, the inputs 302 are matched to known transaction amounts 304, earn rates 306, card types 308, or and/or MCCs 310 to provide an output 314 that indicates whether any of the inputs 302 is associated with an accelerator. This output information 314 is used to determine the rewards points estimate, which is sent to the customer as a real-time notification 316.

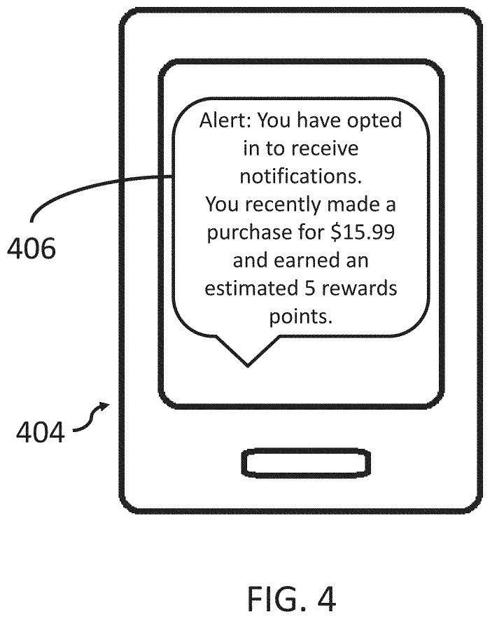

FIG. 4 is an example real-time notification as displayed on a user's computing device 404. In this example, a customer is provided with a pop-up notification 406 on his computing device 404 that states, “Alert: You have opted in to receive notifications. You recently made a purchase for $15.99 and earned an estimated 5 rewards points.” As shown in this example, the notification 406 provides both the transaction amount ($15.99) and the number rewards points estimated for that transaction (5 reward points). The notification further reminds the customer that that customer had previously opted in to receive transaction-related notifications.

In some embodiments, more or less information can be provided in the notification. For example, in some instances, the notification may not remind the customer that he or she has opted in to receive the notifications. In some instances, the notification may remind the user that he or she has opted in to receive the notifications and further provide a link to allow the customer to change the notification settings. In some instances, the notification may include additional information regarding the customer's rewards points balance, including information about the rewards points earned for other transactions. In some instances, the notification may include information about the particular transaction, including the goods or services purchased, the type of goods or services purchased, and/or a merchant associated with the goods or services purchased.

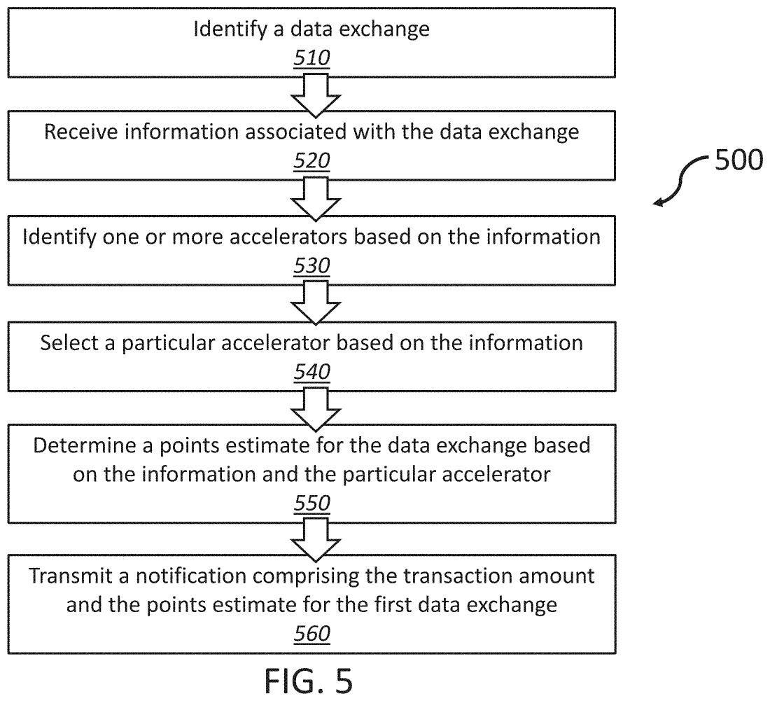

FIG. 5 is a flow chart of a method 500 for determining rewards points estimate for a transaction, according to a first implementation. The method 500 may be performed by one or more computing devices. For example, the method 500 may be performed by the central server 110 shown in FIG. 1, though it may also be performed by other computing devices shown in FIG. 1 or not shown in FIG. 1.

At step 510, a data exchange between a user and an entity is identified. In some instances, the data exchange comprises a transaction between the user and the entity. For example, the data exchange may comprise a user purchasing goods or services. In most cases, the data exchange is identified at the time of its own occurrence (or very close to real-time).

In some instances, the user is a customer. In some instances, the entity is a merchant. In some instances, the data exchange comprises a transaction involving the exchange of goods and/or services for payment of those goods and/or services. In some instances, the data exchange comprises an exchange between a customer and a merchant.

At step 520, information associated with the data exchange is received. This information may include data exchange information such as a card type, a transaction amount, an earn rate, and a merchant category code. The card type information may identify the specific card used in the transaction, including the financial institution that issued the card (e.g., a particular bank or credit card company) and the type of card used (e.g., a credit card or a debit card).

In some instances, where a particular financial institution offers different types or levels of cards, the card may further specify which type or level is used. For example, a financial institution may offer silver, gold, and platinum level credit cards. In this case, the card type may further specify whether the card used in the data exchange is a silver, gold, or platinum level card.

In some instances, a particular company may offer credit cards associated with various financial institutions (e.g., co-branded credit cards). In these cases, the card type information may identify one or both of the company offering the credit card and the particular financial institution associated with the card used in the transaction (e.g., the financial institution with whom the card is co-branded).

For example, a customer completes a transaction using her XYZ Gold Level credit card, which is co-branded with V Company. The transaction comprises a purchase of food for $20 at a ABC Grocery Store. This transaction is identified by a central server, which receives information associated with the transaction, including the card type (e.g., XYZ Gold Level credit card, co-branded with V company), the transaction amount (e.g., $20), and the MCC associated with the merchant (e.g., MCC 5411 for grocery stores).

At step 530, one or more accelerators is identified based on the received data exchange information. The one or more accelerators may be identified based on one or more of the inputs. In some instances the one or more accelerators may be assigned to a particular customer. For example, a customer may have been given a promotional points-earning accelerator, e.g., to encourage the customer to sign up for the method of payment.

In some instances, the one or more accelerators are identified based on the card type. In these instances, particular card types may have associated with them, a list of potential accelerators. The computing device or devices identify these potential accelerators that may be relevant to the rewards points calculation based on the type of card used by the customer in the data exchange.

In the example above, a list of potential accelerators may be identified based the card type—XYZ Gold Level credit card, co-branded with V company. The computing device may include a database with potential accelerators and the card types with which they are associated. An example of potential accelerators associated with the XYZ Gold Level credit card, co-branded with V company, is shown in the example table below:

| Accelerator Level | Points Accelerator |
|---|---|
| Level 1 | Earn 1 point for every $10 spent |
| Level 2 | Earn 1 point for every $8 spent |
| Level 3 | Earn 1 point for every $5 spent |
| Level 4 | Earn 1 point for every $1 spent |

In this example, the computing device (e.g., central server) identifies Levels 1-4 as potential points accelerators based on the card type of XYZ Gold Level credit card, co-branded with V company.

In some instances, one or more additional accelerators may be identified. For example, a customer may have preselected a number of categories (e.g., merchant categories) for which she is eligible to earn rewards points at an accelerated rate. A customer may be permitted to select a certain number of categories—such as travel and gas purchases—for which that customer may earn rewards points at an accelerated rate. In some instances, the customer may be permitted to select a certain number of categories from a list of pre-selected categories. These one or more additional accelerators may then be used in the calculation of estimated rewards points for the particular transaction.

In some instances, a customer may elect to earn points at an accelerated rate, though the accelerated rate may be time-limited. For example, a customer may elect to earn 3× points for the first 4 months of having a particular credit card.

In some instances, a customer may elect to earn points at an accelerated rate, though the accelerated rate may be limited to a certain amount of purchases made in a set time period. For example, a customer may elect to earn 2× points for the first $500 she spends on gas in a month. After the customer earns points on $500 spent on gas in a month, the customer can continue to earn points for gas purchases, but the customer does not earn those points at the accelerated rate of 2× points per dollar.

In some instances, a customer may elect to earn points at an accelerated rate, though the accelerated rate may be limited to a certain number of points that can be earned at the accelerated rate. For example, a customer may elect to earn 4× points for travel purchases, up to a limit of 5,000 points in a month. After 5,000 points are earned at that accelerated rate, the customer may continue to earn points for travel purchases but not at the user-selected accelerator rate (e.g., 4×).

At step 540, a particular accelerator is selected based on the received information associated with the data exchange. The particular accelerator may be selected based on, for example, the MCC. In some instances, the particular accelerator may be selected based on profile information relating to the particular customer, the transaction amount, and/or the date/time of the transaction. In some instances, the particular accelerator is selected based on all of the MCC, customer profile information, the transaction amount, and the date/time of the transaction, or any combination of these factors.

In the example above, the computing device (e.g., a central server) considers the MCC, 5411, to determine which points accelerator level is applicable to the transaction. The computing device may include a database with accelerator levels and the MCCs with which they are associated. An example of accelerator levels and MCCs associated with the XYZ Gold Level credit card, co-branded with V company, is shown in the example table below:

| Accelerator Level | Merchant Category Code (MCC) |
|---|---|
| Level 1 | 5411 (grocery stores), 5541 (service stations), 5912 |
| | (drug stores and pharmacies) |
| Level 2 | 5999 (miscellaneous specialty retail), 5941 |
| | (sporting goods stores), 5942 (book stores) |
| Level 3 | 5812 (eating places, restaurants), 5813 (drinking |
| | paces) 5814 (fast food restaurants) |
| Level 4 | 3000-3299 (airlines), 3351-3441 (car rental), 3501- |
| | 3790 (hotels/motels/inns/resorts) |

In the example, the customer purchased groceries at a merchant with MCC 5411, so a determination is made that accelerator level 1—Earn 1 point for every $10 spent—applies to the particular transaction.

In a second example, a customer may use his XYZ Gold Level credit card, co-branded with V company, to purchase a plane ticket for $600 from LMN Airlines. The MCC associated with LMN Airlines is 3000. In this example, the same potential accelerators—Levels 1-4 discussed in the previous example—would be identified in step 530. At step 540, the MCC of 3000 would be used to identify the appropriate accelerator, Level 4 corresponding to earning 1 point for every $1 spent.

At step 550, a rewards points estimate is determined for the data exchange based on the data exchange information and the selected accelerator. The rewards points estimate may be based on, for example, the transaction amount and the selected accelerator.

In the first example discussed above, the computing device calculates the number of points earned in the transaction based on the transaction amount ($20) and the selected accelerator (“Earn 1 point for every $10 spent”) to yield an estimated 2 points earned in the transaction.

In the second example discussed above, the computing device calculates the number of points earned in the transaction based on the transaction amount ($600) and the selected accelerator (“Earn 1 point for every $1 spent”) to yield an estimated 600 points earned in the transaction.

At step, 560, a notification comprising the transaction amount and the points estimate is transmitted to a computing device associated with the user. In some instances, the notification is transmitted to the user's computing device concurrent with the data exchange (e.g., in real-time).

The customer may be notified of the points estimate by way of notification or alert on the customer's computing device (e.g., smart phone), as shown, for example, in FIG. 4. In some instances, the notification comprising a push notification on the user's computing device. The notification may be provided in real-time (or near real-time) at the time of the transaction so the customer does not need to wait to receive a statement. In some instances, the customer opts in to receive these notifications or alerts and can opt out to not receive them.

In the first example above, the system (e.g., a central server) transmits a notification to the user that for her purchase of $20 at ABC Grocery Store, she has earned an estimated 2 rewards points. In some instances, the notification may further inform the user of the earn rate that applied to the transaction based on the type of transaction or merchant code. For example, the notification may state that the user earned 1 point for every $10 spent on groceries. The notification may further identify the specific card used in the transaction.

In the second example above, the system (e.g., a central server) transmits a notification to the user that for his purchase of a $600 airline ticket from LMN Airlines, he earned an estimated 600 points. The notification may further indicate one or more of the card used in the transaction, the earn rate, and an indication of the merchant type. For example, the notification may indicate that the customer used is XYZ Gold Level credit card, co-branded with V Company, and earned points at a rate of 1 point per $1 spent on the purchase of airline-related goods and services.

In some instances, another data exchange may occur between the user and the entity. This other data exchange may be related to the first data exchange and cause a revision in the points estimate. In some instances, the other data exchange occurs at a time after the first data exchange, and the system may calculate a revised points estimate and transmit the revised estimate to the user. In these instances, it may be necessary to revise the earlier points estimate because the earlier estimate is either too high or too low.

In the second example above, after the customer performs a first transaction at a first time, using his XYZ Gold Level credit card, co-branded with V company, to purchase a plane ticket for $600 for LMN Airlines, the system informs the user that he has earned an estimated 600 rewards points. However, at a second time later than the first time, the user may need to change his plane ticket, resulting instead in the purchase of a plane ticket for $950 from LMN Airlines. In this case, the central server may receive this information relating to the second transaction and revise the rewards point estimate. In particular, using the updated transaction amount, the central server can calculate and updated rewards point estimate of 950 points. The central server then transmits a notification with a revised rewards points estimate of 950 points for the revised transaction amount of $950.

In some instances, for the second transaction, the user may use a different card type. For example, the user may have used his XYZ Gold Level credit card in the first transaction (and canceled that purchase in his second transaction) and used his XYZ Platinum Level credit card in the second transaction for $950. In these cases, the revised estimate may include more information. For example, the XYZ Platinum Level credit card may have the following potential accelerator levels and merchant category codes:

| Accelerator Level | Points Accelerator |
|---|---|
| Level 1 | Earn 5 point for every $10 spent |
| Level 2 | Earn 5 point for every $8 spent |
| Level 3 | Earn 5 point for every $5 spent |
| Level 4 | Earn 5 point for every $1 spent |

| Accelerator Level | Merchant Category Code (MCC) |
|---|---|
| Level 1 | 5411 (grocery stores), 5541 (service stations), 5912 |
| | (drug stores and pharmacies) |
| Level 2 | 5999 (miscellaneous specialty retail), 5941 |
| | (sporting goods stores), 5942 (book stores) |
| Level 3 | 5812 (eating places, restaurants), 5813 (drinking |
| | paces) 5814 (fast food restaurants) |
| Level 4 | 3000-3299 (airlines), 3351-3441 (car rental), 3501- |
| | 3790 (hotels/motels/inns/resorts) |

In this example, at the time of the second transaction, the customer may receive one or more notifications relating to the first and second transactions. The one or more notifications may indicate that the customer earned an estimated 0 points related to the revised first transaction (e.g., for $0) and that the customer earned an estimated 4,650 for the purchase of the $950 plane ticket. As noted above, the one or more notifications may include the earn rates: “Earn 1 point for every $1 spent” and “Earn 5 point for every $1 spent,” respectively. Additionally, the one or more notifications may further indicate information about the transaction type or merchant category code and the card type. For example, the one or more notifications may state that the user earned “1 point for every $1 spent on airline-related purchases with the XYZ Gold Level credit card” and “5 points for every $1 spent on airline-related purchases with the XYZ Platinum Level credit card.”

In some instances, the system further takes into account a data exchange type or transaction type. Data exchange types or transaction types may be categories in a number of ways. For instance, certain types of transactions may be associated with frequent holds. These types of transactions may include, for example, purchases at pay-at-the-pump gas stations, hotels, and rental car services. Other types of transactions may be associated with frequent occurrences of actual transaction amounts different from actual billed amounts. These types of transactions also may include, for example, purchases at pay-at-the pump gas stations, hotels, and rental car services.

The final purchase amounts for some transactions can be unpredictable from unforeseen extras such as room service charges, refueling charges, or longer than anticipated stays. For example, transactions at pay-at-the-pump gas stations frequently involve holds. If a customer makes a purchase of gas using a credit card at the pump by first swiping her credit card, the gas station does not know how much gas will be purchased. Typically, gas stations authorize a fixed amount (e.g., $1) to verify the credit card and to ensure that the user has sufficient funds. The actual amount of the transaction is not known until the user pumps the gas. Thus, purchases at pay-at-the-pump gas stations may be associated with transaction types for which there are frequent holds.

In certain types of transactions, such as transactions for which there are frequent holds or frequent occurrences of actual transaction amounts different from actual billed amounts, the system, or specifically a central server, may include specific logic for addressing the transaction. The logic may dictate, for example, that based on the transaction type, the points estimate not be calculated. In these cases, because the points estimate may not be sufficiently accurate to provide to the user, no points estimate is determined, eliminating the need for unnecessary processing.

In some instances, the logic dictates that, based on the transaction type, that a calculated points estimate is not to be provided to the user. In these cases, the logic may determine that the calculated points estimate is not sufficiently accurate to provide to the user, based on the transaction type. For example, if the transaction type frequently involves an authorization amount that is different from the actual billed amount, the estimated points estimate will also be different from the actual rewards points. As such, providing the points estimate does not in fact help the user, so the logic may dictate that the points estimate not be provided to the user.

In some instances, the logic dictates that, based on the transaction type, the points estimate is to be provided to the user with a disclaimer that the actual credited rewards points total may be different than the estimate. For example, if the transaction type frequently involves an authorization amount that is different from the actual billed amount, the user may be provided with an estimate of the rewards points associated with the transaction but further be provided with a disclaimer that warns the user that the estimated rewards points may not be accurate and/or that the final awarded points may be different from the estimated rewards points.

Users (e.g., customers) may be provided with mobile applications from financial institutions. For example, the issuer of a credit card may provide a mobile application associated with the credit card for credit card users to download and run on their mobile devices. This mobile application may allow credit card users to access their credit card account, including accessing their current account balance, pending transactions, recent transactions, due date of next payment, minimum payment due, and statement balance. The mobile application may further allow users to view rewards points earned through use of the credit card.

Additionally, the mobile application may allow the user to access his or her account settings, including user preferences, including delivery preferences for messages and notifications and the types of notifications or alerts that the user wishes to receive. For example, the user may opt in to receive alerts and notifications relating to estimated rewards points associated with transactions. The user may opt in to receive such alerts and notifications at the time of the transactions rather than, for example, only on the user's monthly statements. The user may also opt in to receive push notifications to receive the rewards points estimates.

When a user opts in to receive notifications and alerts relating to estimated rewards points, the user's mobile computing device running the mobile application receives, from a central server, information indicative of the points estimate. For example, the information may notify the user of the points estimate and the amount associated with the transaction. The points estimate may then be added to a breakdown of points of the user in the user's current billing cycle.

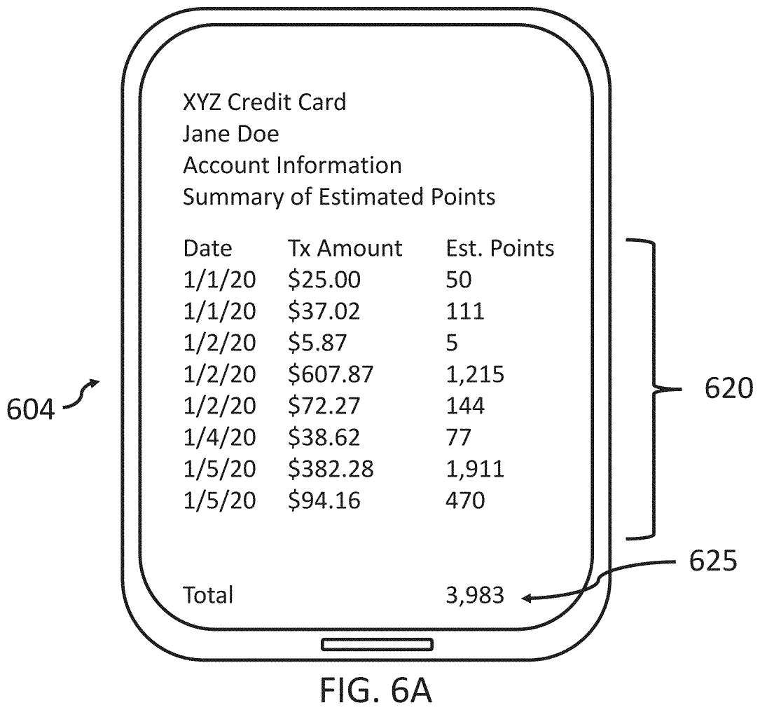

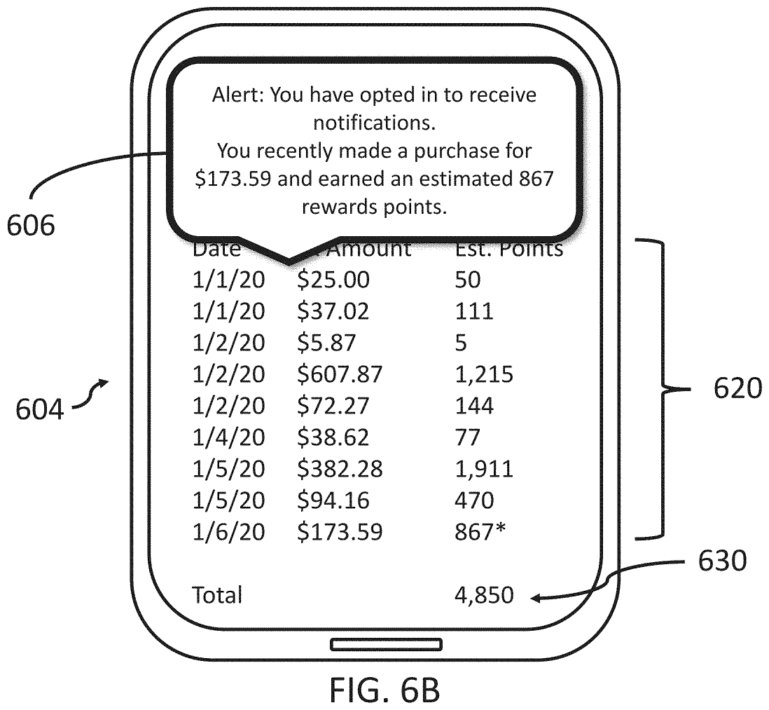

FIGS. 6A and 6B show examples of displays on a user's device. FIG. 6A shows a breakdown of estimated points 620 in a mobile application on a user's computing device 604. FIG. 6B is an example real-time notification 600 as displayed on the user's computing device 604.

FIG. 6A shows a summary of estimated points associated with transactions that a user, Jane Doe, has made using her XYZ Credit Card. As can be shown in the breakdown of estimated points 620, each transaction is listed with a date, a transaction amount, and an estimate of rewards points. In some instances, more or less detail may be displayed in the breakdown of estimated points. For example, information relating to the type of transaction, a merchant associated with the transaction, and/or MCCCs may be displayed. In some instances, a user can select which information to shown in the breakdown. The user's computing device 604 shown in FIG. 6A additionally shows a total of estimated points 625.

FIG. 6B shows a pop-up notification 606 provided on the user's computing device 604 of FIG. 6A that states, “Alert: You have opted in to receive notifications. You recently made a purchase for $173.59 and earned and estimated 867 rewards points.”

The notification 606 overlaps the breakdown of estimated points relating to the user's previous transactions 620. As can be seen below the breakdown of estimated points 620, a new estimated points total 630 of 4,850 is shown, which has updated to include the 867 estimated points from the latest $173.59 transaction. Prior to receipt of the notification 606, the mobile application associated with the user's card was active on the user's mobile device, as shown in FIG. 6A, so when the notification 606 was displayed on the user's device, it is shown overlaid on the breakdown of estimated points 620 in the mobile application.

The notification 606 is not necessarily shown overlaid on the breakdown of estimated points 620. Rather, the notification 606 may be a pop-up or push notification that is displayed on the user's computing device 604 as soon as it is received at the user's computing device 604.

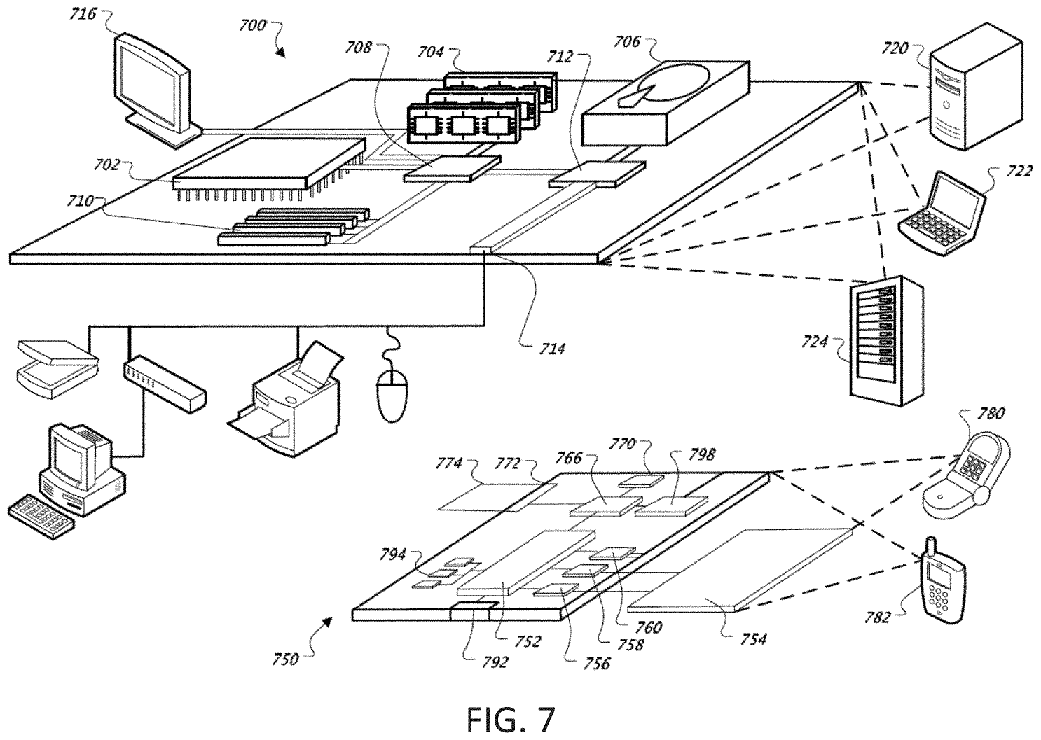

FIG. 7 shows an example of a computer device 700 and a mobile computer device 750 that can be used to implement the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high-speed interface 708 manages bandwidth-intensive operations for the computing device 700, while the low-speed controller 712 manages lower bandwidth-intensive operations. Such allocation of functions is exemplary only. In one implementation, the high-speed interface 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MIMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube), LCD (liquid crystal display), or TFT monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A system comprising:
a memory storing instructions;
a communications interface; and
at least one hardware processor interoperably coupled with the memory and the communications interface, wherein the instructions instruct the at least one hardware processor to:
identify a first data exchange between at least a computing device associated with a user and a computing device associated with an entity;
receive information associated with the first data exchange, the information comprising information indicative of a card type used in the first data exchange, a transaction amount, and a category code associated with the entity;
identify, based on the received information associated with the first exchange, a data exchange type of the first data exchange;
determine, based on the data exchange type, whether to provide a points estimate of the first data exchange to the computing device associated with the user; and
in response to determining to provide the points estimate of the first data exchange to the computing device associated with the user:
identify, based on at least one of the information associated with the first data exchange, one or more accelerators;
select, among the one or more accelerators and based on at least one of the information associated with the first data exchange, a particular accelerator applicable to the first data exchange;
determine, at a time concurrent with the first data exchange, the points estimate for the first data exchange based on the transaction amount and the selected particular accelerator; and
transmit, via the communications interface and to the computing device associated with the user, a notification comprising the transaction amount and the points estimate for the first data exchange, wherein the notification causes the computing device to output, at the time concurrent with the first data exchange and to the user, a sensory notification indicating the transaction amount and the points estimate for the first data exchange.

2. The system of claim 1, wherein the entity comprises a merchant.

3. The system of claim 1, wherein the first data exchange comprises a transaction.

4. The system of claim 1, wherein the notification is provided concurrent with the first data exchange.

5. The system of claim 1, wherein the notification further comprises a breakdown of the points estimate based on the first data exchange.

6. The system of claim 1, wherein the notification comprises a push notification.

7. The system of claim 1, wherein the one or more accelerators are each associated with a respective rate or multiplier.

8. The system of claim 1, wherein the one or more accelerators are identified based on the card type.

9. The system of claim 1, wherein the particular accelerator is selected based on the category code.

10. The system of claim 1, wherein the instructions further instruct the at least one hardware processor to:
identify a second data exchange related to the first data exchange; and
revise the points estimate for the first data exchange based on information associated with the second data exchange.

11. The system of claim 10, wherein the first data exchange is associated with a first time and the second data exchange is associated with a second time, the second time occurring after the first time.

12. (canceled)

13. The system of claim 1, wherein the instructions that instruct the at least one hardware processor to determine, based on the data exchange type, whether to provide the points estimate of the first data exchange to the computing device associated with the user further comprises instructions that instruct the at least one hardware processor to:
based on the data exchange type, determine whether to provide the points estimate of the first data exchange to the user with a disclaimer that the points estimate and actual credited points for the first data exchange may be different.

14. The system of claim 1, wherein the points estimate for the first data exchange is not provided to the user if the data exchange type is associated with at least one of (i) frequent holds or (ii) frequent occurrences of actual transaction amounts differing from actual billed amounts.

15. The system of claim 1, wherein the memory further stores a repository of multiplier-based calculations, data associated with a plurality of card types, and data associated with a plurality of customers.

16. The system of claim 1, wherein the instructions further instruct the at least one hardware processor to:
identify one or more additional accelerators associated with previously-selected categories,
wherein determining the points estimate for the first data exchange is further based on the identified one or more additional accelerators.

17. A non-transitory, computer-readable medium storing computer-readable instructions executable by a computer and configured to instruct the computer to:
identify a first data exchange between at least a computing device associated with a user and a computing device associated with an entity;
receive information associated with the first data exchange, the information comprising information indicative of a card type used in the first data exchange, a transaction amount, and a category code associated with the entity;
identify, based on the received information associated with the first exchange, a data exchange type of the first data exchange;
determine, based on the data exchange type, whether to provide a points estimate of the first data exchange to the computing device associated with the user; and
in response to determining to provide the points estimate of the first data exchange to the computing device associated with the user:
identify, based on at least one of the information associated with the first data exchange, one or more accelerators;
select, among the one or more accelerators and based on at least one of the information associated with the first data exchange, a particular accelerator applicable to the first data exchange;
determine, at a time concurrent with the first data exchange, the points estimate for the first data exchange based on the transaction amount and the selected particular accelerator; and
transmit, to the computing device associated with the user, a notification comprising the transaction amount and the points estimate for the first data exchange, wherein the notification causes the computing device to output, at the time concurrent with the first data exchange and to the user, a sensory notification indicating the transaction amount and the points estimate for the first data exchange.

18. The non-transitory, computer-readable medium of claim 17,
wherein the first data exchange comprises a transaction,
wherein the entity comprises a merchant, and
wherein the notification is provided concurrent with the first data exchange.

19. A computerized method performed by one or more processors, the method comprising:
receiving, at a central server, information associated with a first data exchange between at least a computing device associated with a user and a computing device associated with an entity, the information comprising information indicative of a card type used in the first data exchange, a transaction amount, and a category code associated with the entity;
identifying, based on the received information associated with the first exchange, a data exchange type of the first data exchange;
determining, based on the data exchange type, whether to provide a points estimate of the first data exchange to the computing device associated with the user; and
in response to determining to provide the points estimate of the first data exchange to the computing device associated with the user:
identifying, by the central server and based on at least one of the information associated with the first data exchange, one or more accelerators;
selecting, by the central server and among the one or more accelerators and based on at least one of the information associated with the first data exchange, a particular accelerator applicable to the first data exchange;
determining, by the central server and at a time concurrent with the first data exchange, the points estimate for the first data exchange based on the transaction amount and the selected particular accelerator; and
transmitting, by the central server to a computing device associated with the user, a notification comprising the transaction amount and the points estimate for the first data exchange, wherein the notification causes the computing device to output, at the time concurrent with the first data exchange and to the user, a sensory notification indicating the transaction amount and the points estimate for the first data exchange.

20. The method of claim 19,
wherein the first data exchange comprises a transaction, and
wherein the entity comprises a merchant.
